(19) United States
(12) Patent Application Publication
(10) Pub. No.: US 2010/0085469 A1
(43) Pub. Date: Apr. 8, 2010

(54) USER INPUT APPARATUS, DIGITAL CAMERA, INPUT CONTROL METHOD, AND COMPUTER PRODUCT

(75) Inventor: Hideazu TAKEMASA, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi (JP)

(21) Appl. No.: 12/572,676

(22) Filed: Oct. 2, 2009

(30) Foreign Application Priority Data
Oct. 3, 2008 (JP) 2008-258336

(51) Int. Cl. H04N 5/225; G09G 5/00

(52) U.S. Cl. 348/345; 345/156; 348/E05.024

(57) ABSTRACT

A user input apparatus includes a display screen that displays selectable items; a receiving unit that receives operational input from a user; a display control unit that causes to be displayed on the display screen as objects, the selectable items and a 3-dimensional virtual space centered about a vantage point of the user viewing the display screen; a detecting unit that detects an angular state of the user input apparatus; a focusing unit that focuses a selectable item according to the detected angular state; and a control unit that performs control causing reception of selection that is made via the operational input from the receiving unit and with respect to the selectable item focused by the focusing unit.

### BACKGROUND OF THE INVENTION

1. Field of the Invention

The present invention relates to a user input apparatus, digital camera, and input control method.

2. Description of the Related Art

Conventionally, portable computer apparatuses, such as digital cameras, mobile telephones, personal digital assistants (PDAs), are equipped with four-way directional buttons, jog dials, etc. as input devices enabling, via manual entry by a user, selection from a display screen that displays characters and other selectable items.

In addition to such manual input, selection by a shaking of a terminal device up/down or left/right by the user has been proposed. Specifically, a portable computer apparatus is equipped with an internal inertial sensor and angular motion of the portable computer apparatus caused by the application of an external force by the user is detected to enable selection and entry of an item (see, for example, Japanese Patent Application Laid-Open Publication No. 2006-236355).

However, the above conventional technology is for selection from among an extremely small number of selectable items, e.g., one numeral is selected from among numerals 1 to 9. Thus, a problem arises in that for selection from among a large number of selectable items, operation becomes troublesome. Specifically, for example, even if numerous selectable items (input keys) corresponding to keyboard buttons are displayed on the display screen, in sequentially selecting one input key at a time from among the numerous input keys, the number of times the user has to move the cursor and shake the portable computer apparatus up/down or left/right arises in a problem of poor operability.

### SUMMARY OF THE INVENTION

It is an object of the present invention to at least solve the above problems in the conventional technologies.

A user input apparatus according to one aspect of the present invention includes a display screen that displays selectable items; a receiving unit that receives operational input from a user; a display control unit that causes to be displayed on the display screen as objects, the selectable items and a 3-dimensional virtual space centered about a vantage point of the user viewing the display screen; a detecting unit that detects an angular state of the user input apparatus; a focusing unit that focuses a selectable item according to the detected angular state; and a control unit that performs control causing reception of selection that is made via the operational input from the receiving unit and with respect to the selectable item focused by the focusing unit.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic depicting an overview of an embodiment;

FIG. 2 is a perspective view of a digital camera according to the present embodiment;

FIG. 3 is a rear view of the digital camera;

FIG. 4 is a block diagram of the digital camera;

FIG. 5 is a functional diagram of the digital camera;

FIG. 6 is a schematic depicting the difference in distances when the depth of a 3-dimensional virtual space 102 is short;

FIG. 7 is a schematic depicting the difference in distances when the depth of the 3-dimensional virtual space 102 is long;

FIG. 8 is a schematic depicting the range that a user moves the digital camera in the present embodiment;

FIG. 9 is a table of relationships between directions within a virtual sphere and coordinates when the 3-dimensional virtual space is made planar;

FIG. 10 is a schematic of an example of a display screen when the virtual sphere is made planar;

FIG. 11 is a schematic of apparent coordinates when the movement range of the digital camera is large;

FIG. 12 is a schematic of a display method when displacement on the Z axis is considered;

FIG. 13 is a flowchart of soft keyboard selection processing of the camera according to the present embodiment;

FIG. 14 is a flowchart of selection focus processing;

FIG. 15 is a flowchart of character input processing;

FIG. 16 is a flowchart of input focusing processing;

FIG. 17 is a schematic of a basic screen for a kana input pallet;

FIG. 18 is a schematic of a display screen when character input begins;

FIG. 19 is a schematic of the display screen when the character [symbol] is input;

FIG. 20 is a schematic of the display screen when the character [symbol] is input;

FIG. 21 is a schematic of the display screen when after the character [symbol] followed by the character [symbol] are input;

FIG. 22 is a schematic of the display screen when a focus is moved downward to cause a second and subsequent candidate rows to be displayed;

FIG. 23 is a schematic of the display screen when a candidate is selected;

FIGS. 24 and 25 are schematics of the display screen when zoomed-in on;

FIGS. 26 and 27 are schematics of the display screen when zoomed-out from; and

FIGS. 28 to 33 are schematics of the display screen when a character editing portion and a candidate displaying portion are fixed.

### DETAILED DESCRIPTION OF THE PREFERRED EMBODIMENTS

Referring to the accompanying drawings, exemplary embodiments according to the present invention are explained in detail below.

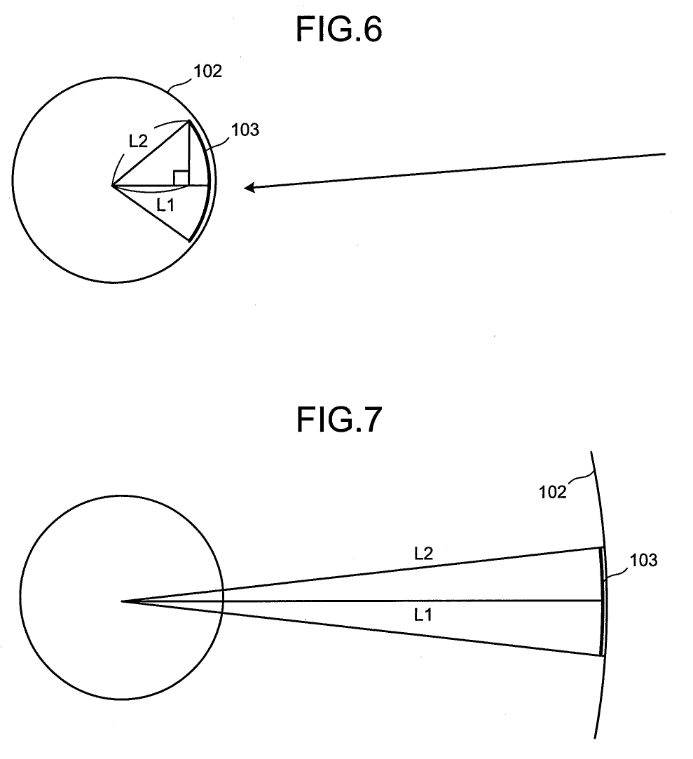

FIG. 1 is a schematic depicting an overview of the present embodiment. As depicted in FIG. 1, a user 101 holds a digital camera 100. The digital camera 100 is, for example, set in an input mode such as a character input mode. A 3-dimensional virtual space 102 center about the user 101 is displayed on a liquid crystal display unit of the digital camera 100. The 3-dimensional virtual space 102 is a virtual sphere having a sufficiently long distance (infinite) enabling the depth of the sphere to be disregarded. Details concerning the depth of the 3-dimensional virtual space 102 are given hereinafter with reference to FIGS. 6 and 7.

On the liquid crystal display unit, from the vantage point of the user 101, soft keyboards 103a to 103c are displayed as objects in front, to the right, to the left and are, for example, a kana (Japanese alphabet) input pallet, a Latin alphabet input pallet, and a character code table. The soft keyboards 103 are drawn in portioned areas of the virtual sphere; the portioned areas are approximately planar.

In the viewable direction of the user 101 depicted in FIG. 1, the soft keyboard 103a is displayed (on the liquid crystal display unit) in the portioned area that is front of the user 101. From this state, for example, if the user 101 faces to the right, a screen is displayed on the liquid crystal display unit where the soft keyboard 103b is in the position in front of the user 101. Further, for example, if the user 101 approaches the soft keyboard 103a or uses a zoom button on the digital camera 100 to zoom-in on the soft keyboard 103a, the display of the soft keyboard 103a is enlarged.

If the user 101 chooses a character on the soft keyboard 103a, causes the chosen character to be in the center of the liquid crystal screen (focuses), and presses the shutter button, the character becomes selected and input. In the following description, unless otherwise specified, “focus” does not mean to make the image of an object clear at the time of photographing, but rather is to make an item, such as a character, chosen for input by the user 101 to be in a selected state. Specifically, “focus” is a state in which a cursor (displayed on the liquid crystal screen as a circle) overlaps a chosen character.

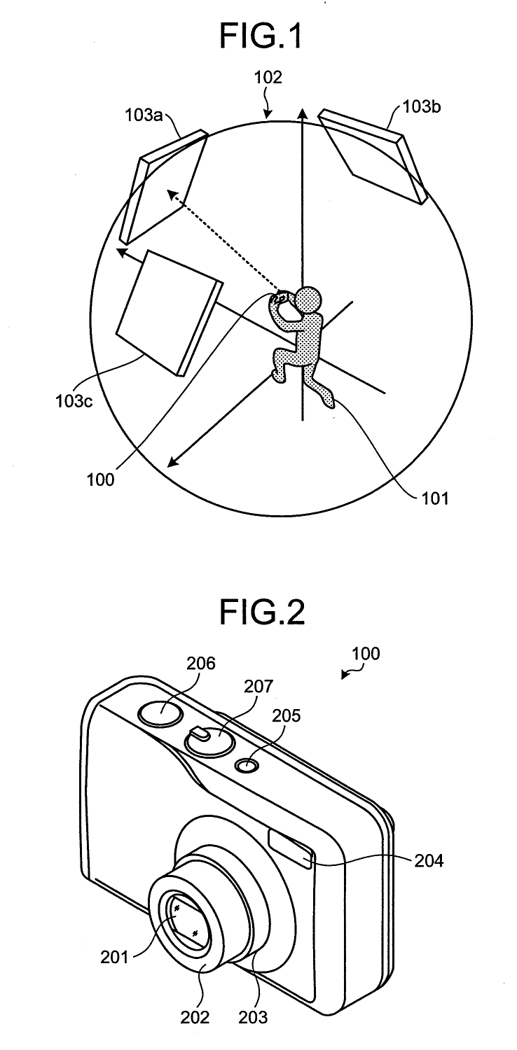

FIG. 2 is a perspective view of the digital camera 100 according to the present embodiment. As depicted in FIG. 2, a lens barrel 202, in which a photographic lens 201 is mounted, is equipped on a front aspect of the digital camera 100. The lens barrel 202 is housed in a lens barrel housing unit 203 when the power is off, and is projected from the lens barrel housing unit 203 to a given position when the power is on. A transparent flash window 204 that protects a flash generating unit is equipped on the front aspect of the digital camera 100.

A power button 205 for changing the power supply state of the digital camera 100, a shutter button 206 used for shutter release, and a mode setting dial 207 for switching between various modes are equipped on an upper aspect of the digital camera 100. The various modes include a photography mode for recording still images, a video mode for recording moving images, a playback mode for viewing recorded still images, a menu mode for changing settings manually, and a character input mode for performing various types of editing.

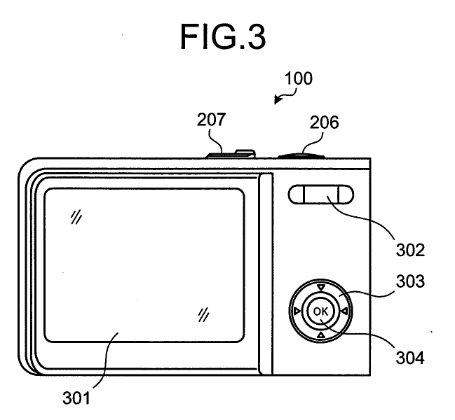

FIG. 3 is a rear view of the digital camera 100. As depicted in FIG. 3, a display 301 is provided (as the liquid crystal display unit) on a rear aspect of the digital camera 100. To a side of the display, a zoom button 302, a direction button 303, and an enter button 304 are provided.

An object is displayed on the display 301. The zoom button 302, when pressed by the user 101, causes zooming-in on or zooming out from the object displayed on the display 301. The direction button 303 is manipulated for selection of various settings, such as a mode. The enter button 304 is manipulated to enter various settings, such as a mode.

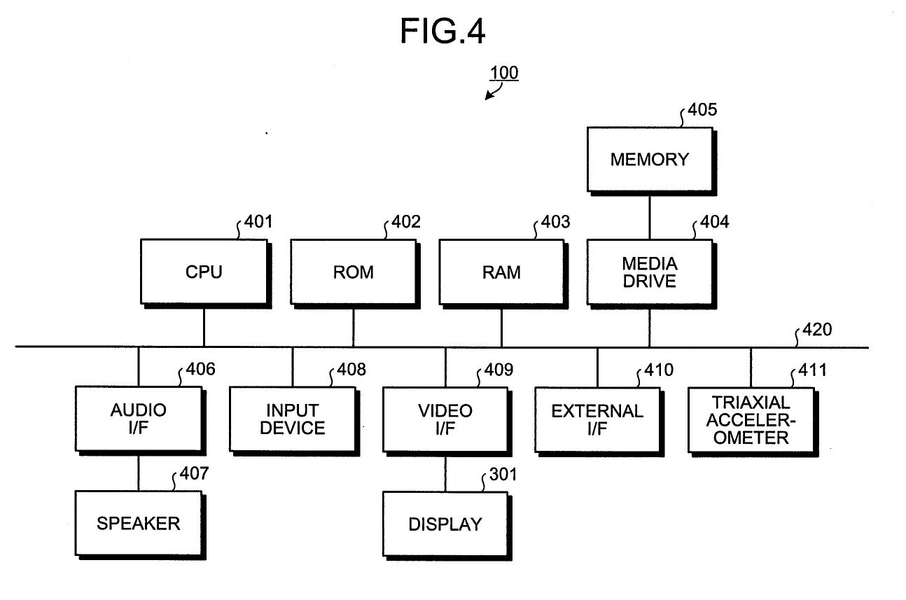

FIG. 4 is a block diagram of the digital camera 100. As depicted in FIG. 4, the digital camera 100 includes a CPU 401, a ROM 402, a RAM 403, a media drive 404, a memory 405, an audio interface (I/F) 406, a speaker 407, an input device 408, an image I/F, the display 301, an external I/F 410, and a triaxial accelerometer 411, respectively connected through a bus 420.

The CPU 401 governs overall control of the digital camera 100. The ROM 402 store therein various programs, such as a boot program, a photography program, and an input control program. The RAM 403 is used as a work area of the CPU 401.

The input control program, in the character input mode, causes display of the soft keyboards 103 within the 3-dimensional virtual space 102 that is centered about the vantage point of the user holding the camera 100, and according to the angular state of the digital camera 100 detected by the triaxial accelerometer 411, causes focusing of a soft keyboard 103 from which the user selects a character to be received via the input control program.

The media drive 404, under the control of the CPU 401, controls the reading and the writing of data with respect to the memory 405. The memory 405 records data written thereto under the control of the media driver 404. A memory card, for example, may be used as the memory 405. The memory 405 stores therein image data of captured images.

The audio I/F 406 is connected to the speaker 407. Shutter sounds, audio information of recorded video, etc. are output from the speaker 407. The input device 408 corresponds to the zoom button 302, the direction button 303, and the enter button 304 depicted in FIG. 3, and receives the input of various instructions.

The video I/F 409 is connected to the display 301. The video I/F 409 is made up of, for example, a graphic controller that controls the display 313, a buffer memory such as Video RAM (VRAM) that temporarily stores immediately displayable image information, and a control IC that controls the display 301 based on image data output from the graphic controller.

Various types of data, such as still images, video, text, icons, a cursor, menus, windows, etc., are displayed on the display 301. The display 301 may be a cathode ray tube (CRT), thin-film-transistor (TFT) liquid crystal display, etc.

The external I/F 410, for example, functions as an interface with an external device such as a personal computer (PC) and a television, and has a function of transmitting various types of data to external devices. The external I/F 410, for example, may be configured by a USB port.

The triaxial accelerometer 411 outputs information enabling the determination of the angular state of the digital camera 100. Values output from the triaxial accelerometer 411 are used by the CPU 401 in the calculation of a focusing position, changes in speed, direction, etc.

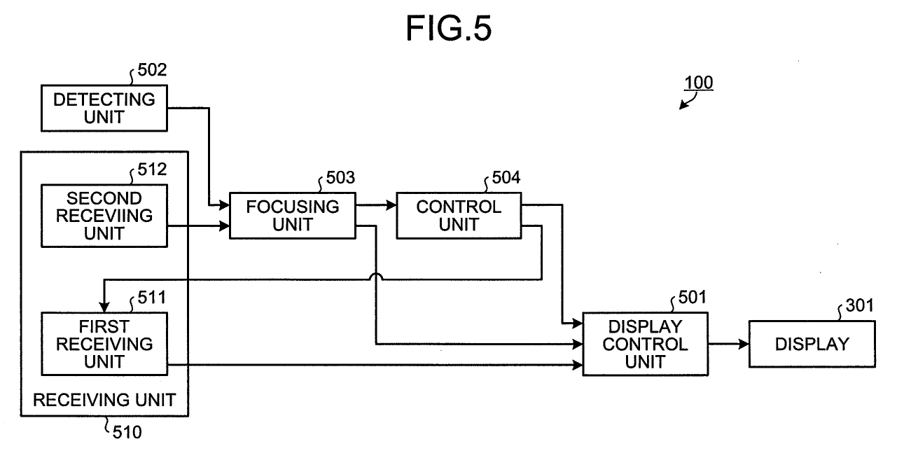

FIG. 5 is a functional diagram of the digital camera 100. As depicted in FIG. 5, the digital camera 100 includes the display 301, a display control unit 501, a detecting unit 502, a focusing unit 503, a control unit 504, and a receiving unit 510.

Functions of the display control unit 501, the focusing unit 503, and the control unit 504 are implemented by the CPU 401 depicted in FIG. 4. Specifically, execution of the input control program by the CPU 401 implements these functions. A function of the detecting unit 502 is implemented by the triaxial accelerometer 411 depicted in FIG. 4. A function of the receiving unit 510 is implemented by the input device 408 depicted in FIG. 4.

The display control unit 501 causes the 3-dimensional virtual space 102 of a spherical shape centered about the vantage point of the user viewing the display 301 to be displayed on the display 301 together with the soft keyboards 103 that are displayed as objects in the 3-dimensional virtual space 102. The display of the 3-dimensional virtual space 102 centered about the vantage point of the user 101 includes a 3-dimensional virtual space 102 centered about the digital camera 100. Although details are described with reference to FIGS. 6 to 8 hereinafter, if the tilt of the digital camera 100 by user manipulation is assumed to be small, the distance from the vantage point of the user 101 to the display 301 may be disregarded and in this case, the 3-dimensional virtual space 102 centered about the digital camera 100, rather than the vantage point of the user 101, may be displayed.

In the present embodiment, the 3-dimensional virtual space 102 is of a spherical shape; however, configuration is not limited hereto and provided the virtual space is 3-dimensional, the shape may be arbitrary, e.g., a rectangular shape. Further, the soft keyboards 103 are used as selectable items; however configuration is not limited hereto and captured images that are editable, a schedule planner, etc. may be used.

The receiving unit 510 receives operational input from the user 101. Although operation buttons provided on the digital camera 100 or an arbitrary input device 108 may be used, typically, the receiving unit 510 is formed by a first receiving unit 511 (shutter button 206) for capturing images and a second receiving unit 512 (zoom button 302) for zooming-in on and zooming out from an object.

The detecting unit 502 detects the angular state of the digital camera 100. In the present embodiment, an internally provided triaxial accelerometer 411 is used as the detecting unit 502; however, an accelerometer that is biaxial, quadraxial or greater may be used. Further, configuration is not limited to an internal sensor and may be, for example, a mechanical or optical sensor that measures displacement, acceleration, etc. of the digital camera 100 externally.

The focusing unit 503 causes a soft keyboard 103 (or characters on a soft keyboard 103) to become focused according to the angular state of the camera 100. The angle is the tilt of the digital camera 100 and specifically, is the slight angle corresponding to the angle at which the user 101 tilts the camera 100 when photographing an object.

In the present embodiment, the focusing position is moved in the same direction as the angular direction to focus the soft keyboard 103. However, the focusing position need not be moved in the same direction as the angular direction provided the focusing position is moved correspondingly to the angular direction. Specifically, for example, the focusing position may be moved in the opposite direction as the angular direction. If the selectable items are captured images, a schedule planner, etc., the focusing unit 503, may cause the captured images, the schedule planner, etc. to become focused according to the angular state of the camera 101.

The control unit 504 performs control to receive the selection of the soft keyboard 103 focused by the focusing unit 503 (or a selected character on the focused soft keyboard 103), the selection being made via operational input to the receiving unit 510. Although an arbitrary operation button may be used as the receiving unit 510, in the present embodiment, selection by the user 101 is received through the first receiving unit 511 (shutter button 206).

The control unit 504 may cause the soft keyboard 103 focused by the focusing unit 503 or characters on the soft keyboard 103 to be read aloud or output in Braille.

The focusing unit 503, when the soft keyboard 103 has been focused, causes the soft keyboard 103 to be zoomed-in on or zoomed-out from according to operational input from the second receiving unit 512 (zoom button 302) for zooming-in on and out from an object. Without limitation to operational input from the second receiving unit 512, the focusing unit 503 may cause the soft keyboard to be zoomed-in on or out from according to the angular state of the camera 100.

The focusing position of the soft keyboard 103 when input commences (when the character mode is initiated) is an initial position. The focusing position when the character input mode is initiated may be the previous focusing position when the character input mode was terminated or may be a predetermined initial position.

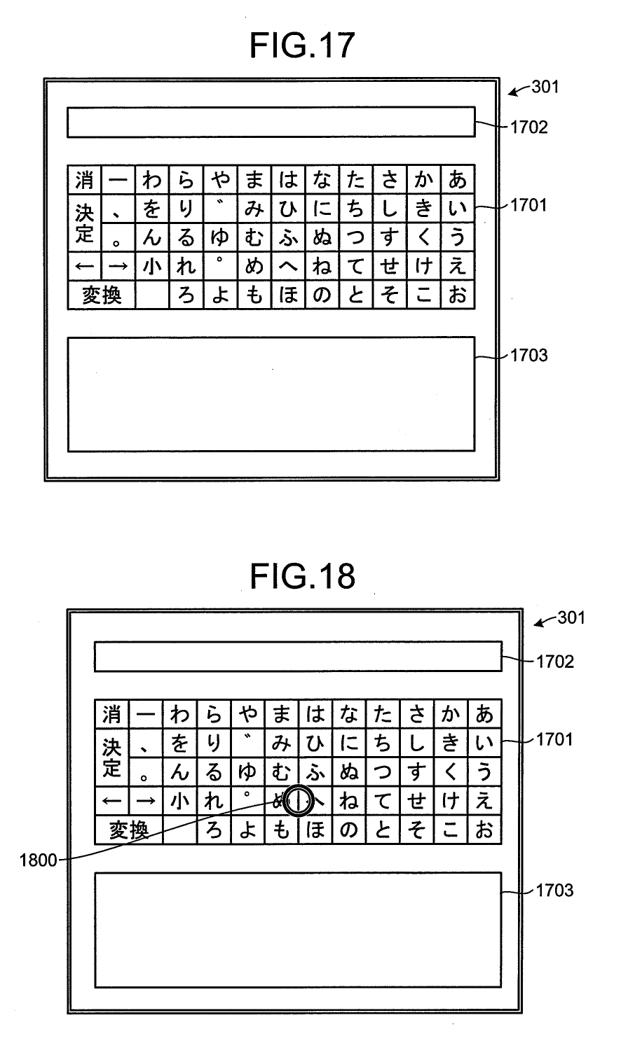

In addition to characters on the soft keyboard 103 focusable by the focusing unit 503, the display control unit 501, on the screen displaying characters on the soft keyboard 103, causes display of a character editing portion that displays selected characters and a candidate displaying portion that displays character strings that are estimated from the characters displayed in the character editing portion. Details are described hereinafter with reference to FIGS. 17 to 27.

When focusing the characters on the soft keyboard 103, the display control unit 501 may cause a fixed display, without moving the character editing portion and the candidate displaying portion according to the movement of the focusing. Details are described hereinafter with reference to FIGS. 28 to 33.

With reference to FIGS. 6 to 12, principles of the display of the 3-dimensional virtual space 102 will be described.

FIG. 6 is a schematic depicting the difference in distances when the depth of the 3-dimensional virtual space 102 is short. FIG. 7 is a schematic depicting the difference in distances when the depth of the 3-dimensional virtual space 102 is long.

As depicted in FIG. 6, the spherically shaped 3-dimensional virtual space 102, for example, has a radius of some tens of centimeters. In this case, because there is a difference between the distances L1 and L2, when the soft keyboard 103 is drawn, if the soft keyboard 103 is made planar, the image is unnatural and thus, an image giving a perception of depth should be drawn.

On the other hand, as depicted in FIG. 7, the 3-dimensional virtual space 102 is infinite. In this case, the difference between the distances L1 and L2 may be disregarded. Consequently, when the soft keyboard 103 is drawn, the soft keyboard 103 may be drawn as a plane. In this manner, in the present embodiment, by making the 3-dimensional virtual space 102 infinite, the soft keyboard 103 may be drawn planar.

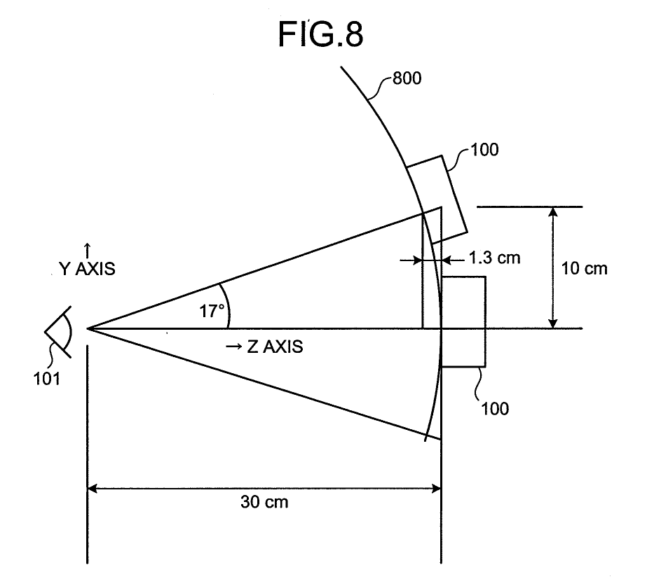

FIG. 8 is a schematic depicting the range that the user 101 moves the digital camera 100 in the present embodiment. Here, based on the detection results from the triaxial accelerometer 411, the value obtained as the absolute displacement on the XYZ coordinate system is regarded as displacement Pm(x, y, z). In the coordinate system, the X axis is along the horizontal direction (the direction in which the arms move when moved left and right), the Y axis is in the vertical direction (the direction in which the arms move when moved up and down), the Z axis is in the direction of depth (the direction in which the arms move when moved to the front and rear).

When the digital camera 100 is operated, the user 101 moves the digital camera 100 within an actual sphere 800 having a radius equivalent to the length of the user's arm and a center at the user's eye. During actual operation of the digital camera 100, the elbows of the user 101 are slightly bent and with consideration of individual differences, the radius of the actual sphere is, for the most part, approximately 30 cm. In reality, the range of motion by the user 101 within the actual sphere 800 covers the entire actual sphere 800. However, with consideration of ease of understanding and practicability, the range of motion in the actual sphere 800 is limited to an approximately 20 cm-range in front of the user 101 (±10 cm up/down and to the left/right relative to the front as a center).

As depicted in FIG. 8, when the radius of rotation is 30 cm and the displacement is 10 cm, the greatest angle of elevation is 17°. When the angle of elevation is 17°, displacement along the Z axis with respect to the origin is:

Δz=30−cos 17°≈1.3(cm)

Here, there is a 1.3 cm deviation and with consideration that during actual movement, due to the difference in the positions of the eye and of the base of the arm of the user 101, variations in the degree of flexion of the elbow (the degree of extension of the arm), etc., true rotation does not occur and the movement of the digital camera 100 is within the coordination range of the user 101; thus, it may be considered that a sphere corresponding to the 20 cm-movement range of the user 101 is nearly a plane that is 20 cm in each direction.

Thus, if the amount of movement is limited to a narrow range, movement along a curve may be considered entirely as planar movement and although logically, the soft keyboard 103 to be drawn on the display screen is spherical, by making the 3-dimensional virtual space 102 infinite, the drawing of the soft keyboard 103 may be regarded as planar.

As described, if the soft keyboard 103 is planar, among the displacements Pm(x, y, z) on the XYZ axes obtained as absolute displacements, displacement on the Z axis may be disregarded, and the soft keyboard 103 may be 2-dimensional along the XY axes.

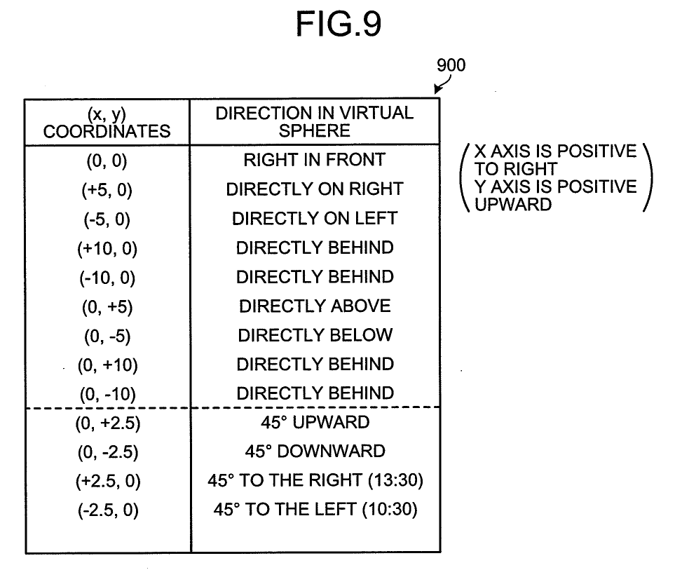

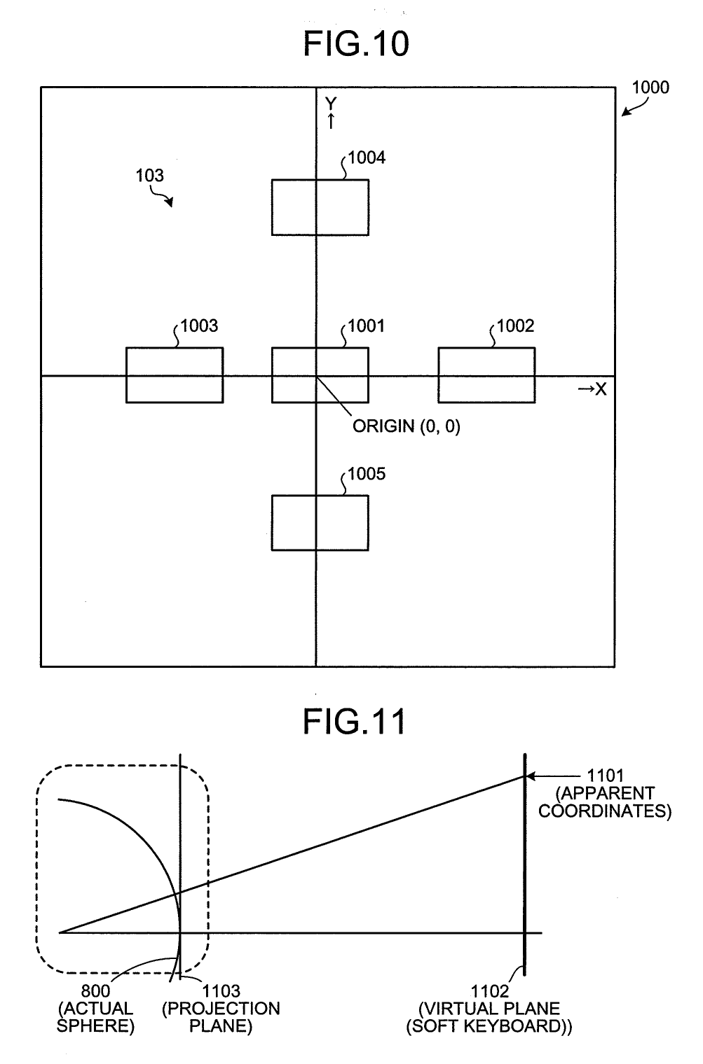

FIG. 9 is a table of relationships between directions within the virtual sphere and coordinates when the 3-dimensional virtual space is made planar. As depicted in a table 900 of FIG. 9, when an entire 360° virtual sphere (complete sphere) for movement 10 cm up, down, to the right and left is drawn, the range of movement along the X axis and the Y axis is −10 cm to +10 cm. The X axis is positive to the right and the Y axis is positive upward. The direction in the virtual sphere to be actually drawn is as depicted in table 900. A specific example of making a virtual sphere planar by using a table such as table 900 will be described with reference to FIG. 10.

FIG. 10 is a schematic of an example of a display screen when the virtual sphere is made planar. A display screen 1000 depicted in FIG. 10 displays a virtual plane that is actually drawn. On the display screen 100, a kana input pallet 1001 is drawn in front (coordinates 0, 0), a Latin alphabet input pallet 1002 is drawn on the right (coordinates +5, 0), a character code table 1003 is drawn on the left (coordinates −5, 0), a symbol list 1004 is drawn upward (coordinates 0, +5), and a list of predefined expressions 1005 is drawn downward (coordinates 0, −5), as soft keyboards 103.

The display screen 1000 sets a plane having a right edge (x=+10), a left edge (x=−10), an upper edge (y=+10) and a lower edge (y=−10) as a virtual posterior boundary that is disconnected and beyond which movement is not possible. To implement this relationship by a program, the soft keyboard 103 is arranged in an XY plane such that X:Y is a 1:1 relationship.

On the display screen 1000, the range of the X axis and the Y axis is 20 cm in the present example; however, configuration is not limited hereto and the range may be determined according to the scale necessary (scalable range displayed) to draw the soft keyboard 103, the resolution of the screen to be actually displayed, etc.

Coordinates Pv(x, y) on the plane with respect to the XYZ axes displacement Pm(x, y, z) obtained as absolute displacement, may be expressed as a simple linear transform equation.

Pv(x,y)=C×Pm(x,y,z)

Where, C is a constant for converting the XY coordinate system, which projects the coordinates on the actual sphere 800, to coordinates on the above virtual plane. In this case, for example, if the drawing range of the display screen 1000 is 1000×1000 dots and the precision of detection of displacement is 0.1 cm, a unit of movement on the soft keyboard 103 is 1000/200=5 (dots).

In the description thus far, displacement on the Z axis has been disregarded; however, displacement on the Z axis may be used in scaling (expanding/reducing display size) the display of the soft keyboard 103. FIG. 11 is a schematic of apparent coordinates when the movement range of the digital camera 100 is large. The apparent coordinates when the user 101 moves the digital camera 100 a large amount is the point indicated by reference numeral 1101 on the same plane as a virtual plane 1102.

Thus, when the user moves the digital camera 100 a large amount, i.e., the angle of elevation is equal to or greater than a fixed value, displacement on the Z axis cannot be disregarded. Further, accompanying the increase in the angle of elevation, the speed of movement on the virtual plane becomes slow. If the angle of elevation is equal to or greater than the fixed value, using a projection plane 1103, the subject is displayed at a position where the angle of elevation is relatively smaller.

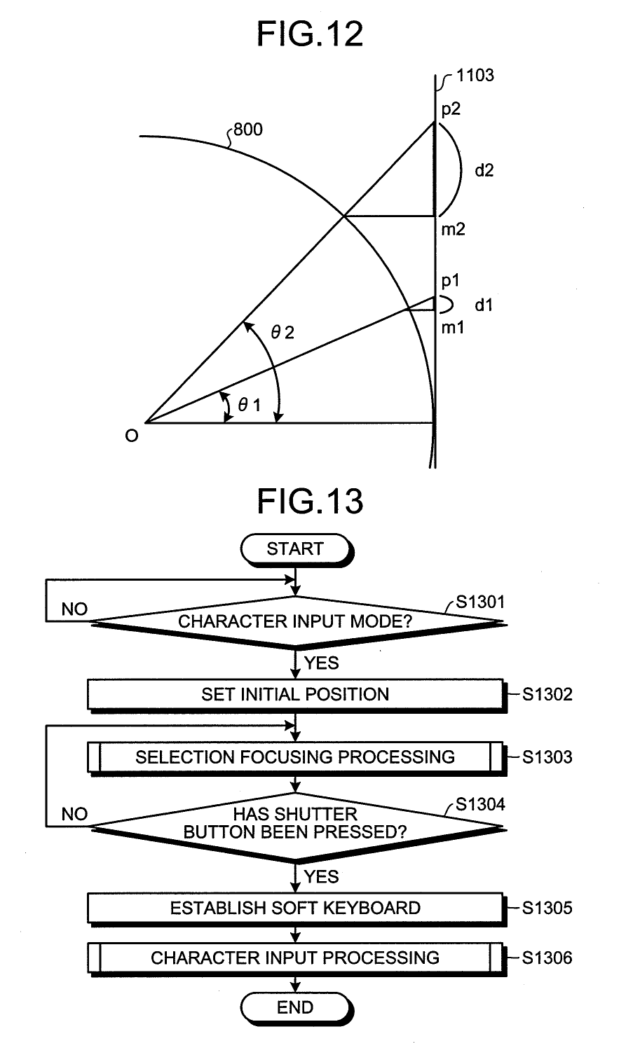

FIG. 12 is a schematic of a display method when displacement on the Z axis is considered. In FIG. 12, p1 on the projection plane 1103 indicates the projection coordinates when the angle of elevation is θ1; m1 indicates the actual coordinates when the angle of elevation is θ1; p2 indicates the projection coordinates when the angle of elevation is θ2; and m2 indicates the actual coordinates when the angle of elevation is θ2. The angle of elevation actually measured (the angle formed with respect to a line connecting the center 0 and m1 or m2) becomes relatively smaller than the expected angle of elevation (θ1 or θ2) concerning appearance. In other words, even if the user 101 moves to p1 or p2, the movement is actually only to m1 or m2.

The larger the angle of elevation is, the larger the error between the projection coordinates and the actual coordinates becomes. Specifically, the error (d2) between the projection coordinates p2 and the actual coordinates m2 for the angle of elevation θ2 is greater than the error (d1) between the projection coordinates p1 and the actual coordinates m1 for the angle of elevation θ1.

If it is considered that movement along the actual sphere 800 is limited within a specified range, without calculating the detected displacement along the Z axis, an arbitrary point P(x, y, z) on the actual sphere 800 can be compensated using the relationship x2+y2+z2=r2 and a correction table obtained by a conversion formula for the coordinate system projected in the plane adjoining a point on the actual sphere 800 and the point of origin on the actual sphere 800. The coordinate system is a coordinate system projected on a plane that contacts the sphere surface at a point on the sphere surface at the same longitude from the center of the sphere (Mercator projection). The correction table is not calculated dynamically using a trigonometric function, but rather is table of values preliminarily calculated for values on the Y axis.

Configuration includes the specified range because, as depicted in FIG. 12, as the angle of elevation approaches 90°, error becomes infinitely large and at an angle of elevation of 90°, projection becomes logically impossible. Further, if the angle of elevation becomes large, the multiplied correction value becomes large and the amount of movement per detection unit for coordinates in actual sphere 800 becomes large and thus, small movements are no longer possible.

FIG. 13 is a flowchart of soft keyboard selection processing of the camera 100 according to the present embodiment.

As depicted in FIG. 13, the CPU 401 of the digital camera 100 determines whether the character input mode has been set through a user operation of the mode setting dial 207 (step S1301). Waiting occurs until the character input mode is set (step S1301: NO). When the character input mode has been set (step S1301: YES), setting of an initial position, as the focusing position displayed at the initiation of the character input mode, is performed (step S1302).

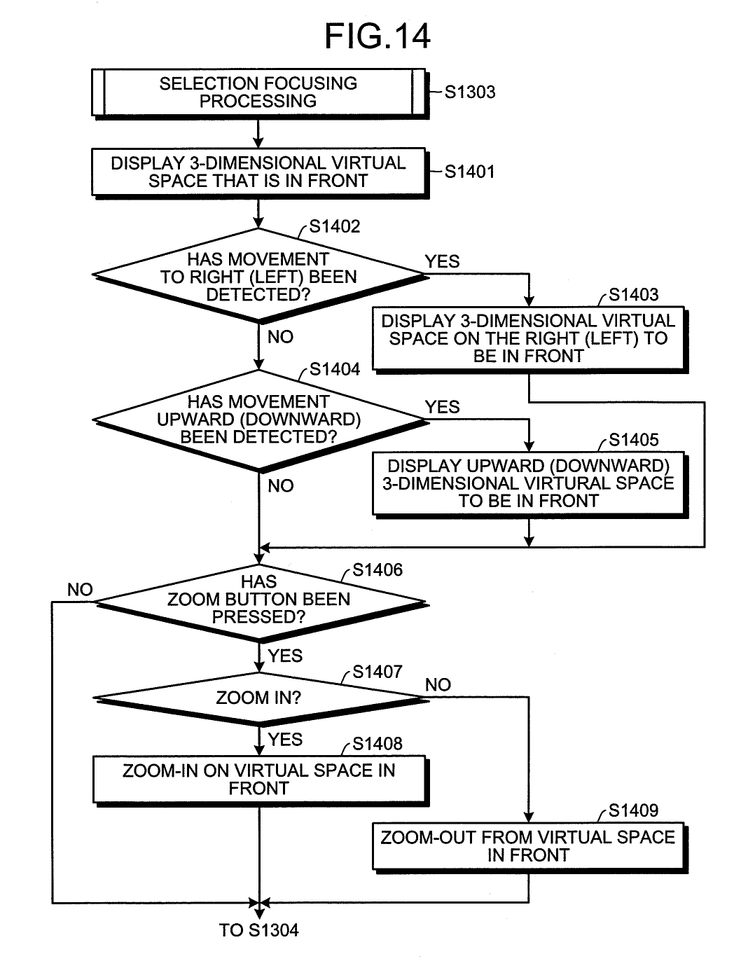

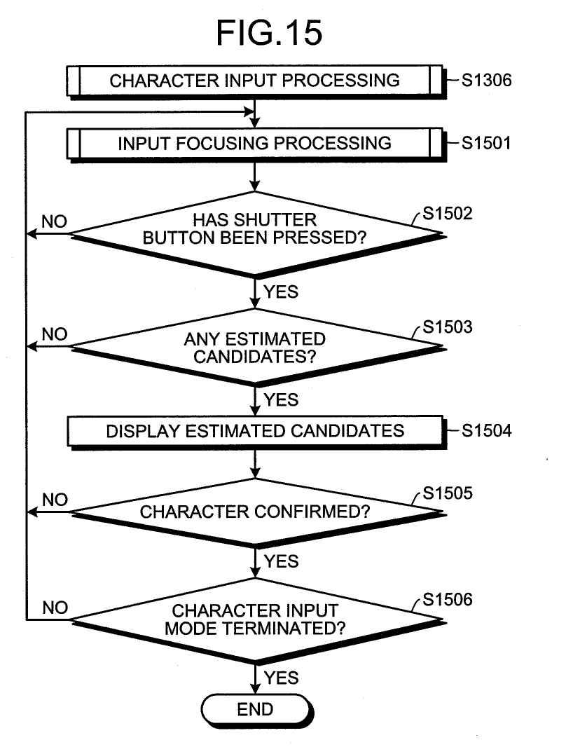

Subsequently, selection focusing processing (see FIG. 14) is executed (step S1303), and it is determined whether the shutter button 206 has been pressed (step S1304). If it is determined that the shutter button 206 has not been pressed (step S1304: NO), the processing returns to step S1303. If it is determined that the shutter button 206 has been pressed (step S1304: YES), the soft keyboard 103 is established (step S1306) and subsequently, character input processing (see FIG. 15) is executed (step S1306).

FIG. 14 is a flowchart of selection focus processing. As depicted in FIG. 14, the selection focus processing (step S1303) involves displaying multiple soft keyboards according to the initial position and the 3-dimensional virtual space 102 in front (step S1401). Using the triaxial accelerometer 411, it is determined whether movement of the digital camera 100 to the right (left) has been detected (step S1402). If it is determined that movement to the right (left) has been detected (step S1402: YES), the 3-dimensional virtual space 102 to the right (left) is displayed to be in front (step S1403).

On the other hand, at step S1402, if it is determined that movement to the right (left) has not been detected (step S1402: NO), it is determined whether movement upward (downward) has been detected (step S1404). If movement upward (downward) has been detected (step S1404: YES), the 3-dimensional virtual space 102 located upward (downward) is displayed to be in front (step S1405). If movement upward (downward) has not been detected (step S1404: NO), it is determined whether the zoom button 302 has been pressed (step S1406).

At step S1403, after the 3-dimensional virtual space 102 to the right (left) is displayed in front, and at step S1405, after the 3-dimensional virtual space 102 located upward (downward) is displayed in front, the processing proceeds to step S1406. At step S1406, if it has been determined that the zoom button 302 has been pressed (step S1406: YES), it is determined whether the zoom button 302 has been manipulated for zoom-in (step S1407). If manipulation is for zoom-in (step S1407: YES), the 3-dimensional virtual space 102 in front is zoomed-in on (step S1408), and the processing proceeds to step S1304 depicted in FIG. 13.

At step S1407, if manipulation is not for zoom-in (step S1407: NO), i.e., is for zoom-out, the 3-dimensional virtual space 102 in front is zoomed-out from (step S1409), and the processing proceeds to step 1304. Further, at step 1406, if the zoom button 302 has not been pressed (step S1406: NO), the processing proceeds to step S1304.

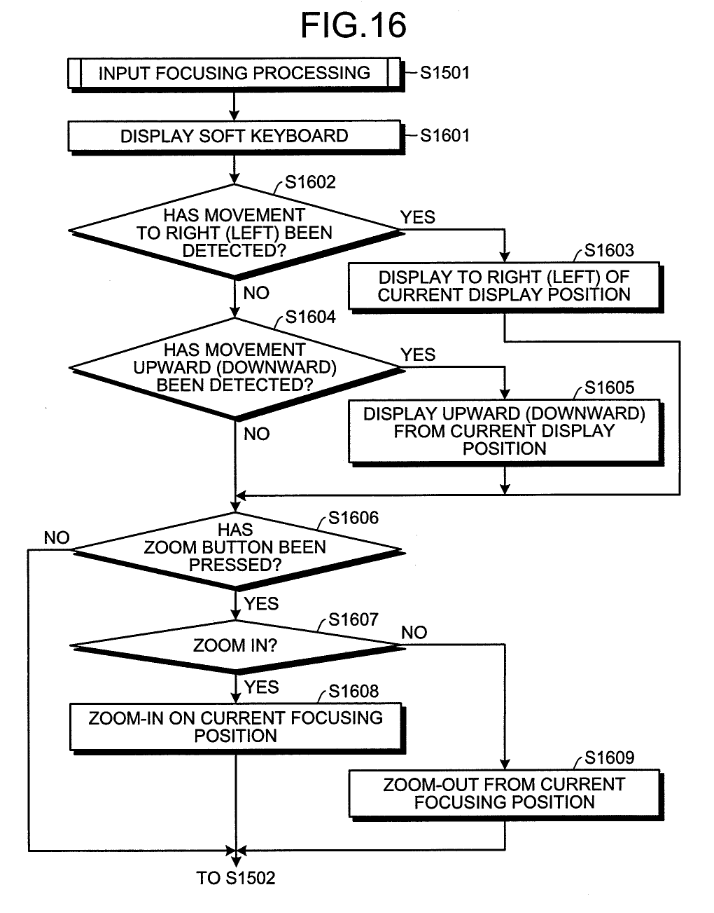

FIG. 15 is a flowchart of character input processing. As depicted in FIG. 14, character input processing (step S1306) includes execution of input focusing processing (see FIG. 16) (step S1501), and determining whether the shutter button 206 has been pressed (step S1502). If the shutter button 206 has not been pressed (step S1502: NO), the processing returns to step 1501. If the shutter button 206 has been pressed (step S1502; YES), it is determined whether there is an estimated candidate (step 1503). If there is no estimated candidate (step S1503: NO), the processing returns to step S1501.

If a candidate has been estimated (step S1503: YES), the estimated candidate is displayed (step S1504). Subsequently, it is determined whether a character has been confirmed by a pressing of the enter button 304 (step 1505). If a character has not been confirmed (step S1505: NO), the processing returns to step S1501. If a character has been confirmed (step S1505: YES), it is determined whether the character input mode has been terminated by a user operation of the mode setting button 207 (step S1506). If the character input mode has not been terminated (step S1506: NO), the processing returns to step 1501. If the character input mode has been terminated (step S1506: YES), a series of the processing ends.

FIG. 16 is a flowchart of input focusing processing. As depicted in FIG. 15, the input focusing processing (step S1501) includes displaying the soft keyboard 103 established through the soft keyboard selection processing depicted in FIG. 13 (step S1601), and by using the triaxial accelerometer 411, determination of whether movement of the digital camera 100 to the right (left) has been detected (step S1602). If movement to the right (left) has been detected (step S1602; YES), the soft keyboard 103 is displayed to the right (left) from the current displaying position (step S1603).

On the other hand, at step S1602, if movement to the right (left) has not been detected (step S1602: NO), it is determined whether movement upward (downward) has been detected (step S1604). If movement upward has been detected (step S1604: YES), the soft keyboard 103 is displayed upward (downward) from the current position (step S1605). If movement upward (downward) has not been detected (step S1604: NO), it is determined whether the zoom button 302 has been pressed (step S1606).

At step S1603, after display to the right (left) of the current position, and at step S1605, after display upward (downward) from the current position, the processing proceeds to step S1606. At step S1606, if it has been determined that the zoom button 302 has been pressed (step S1606: YES), it is determined whether manipulation of the zoom button 302 is for zoom-in (step S1607). If the manipulation is for zoom-in (step S1607: YES), the current focusing position is zoomed-in on (step S1608), and the processing proceeds to step S1502 depicted in FIG. 15. Although details of the display screen will be described hereinafter with reference to FIGS. 28 to 33, control for zooming in, may be such that the character editing portion and the candidate displaying portion displayed on the display screen are fixed without being moved according to the focusing movement.

At step S1607, if manipulation is not for zoom-in (step S1607: NO), i.e., is for zoom-out, the current focusing position is zoomed-out from (step S1609), and the processing proceeds to step S1502. Further, at step S1606, if it is determined that the zoom button 302 has not been pressed (step S1606: NO), the processing proceeds to step S1502.

With reference to FIGS. 17 to 27, an example of a display screen will be described. FIG. 17 is a schematic of a basic screen for the kana input pallet. As depicted in FIG. 17, a character pallet portion 1701, a character editing portion 1702, and a candidate displaying portion 1703 are displayed on the display 301. The character pallet portion 1701 includes multiple input keys. When the user 101 selects an input key located at a focusing position, the selected key is displayed in the character editing portion 1702. The candidate displaying portion 1703 displays character strings such as words estimated from the characters displayed in the character editing portion 1702.

FIG. 18 is a schematic of the display screen when character input begins. In FIG. 18, a focus 1800 is displayed in a central portion of the display screen. The position that the focus 1800 faces at the time when character input begins is the initial position. Thus, when character input begins, the soft keyboard 103 is displayed at the initial position and the focus 1800 is positioned centrally on the soft keyboard 103.

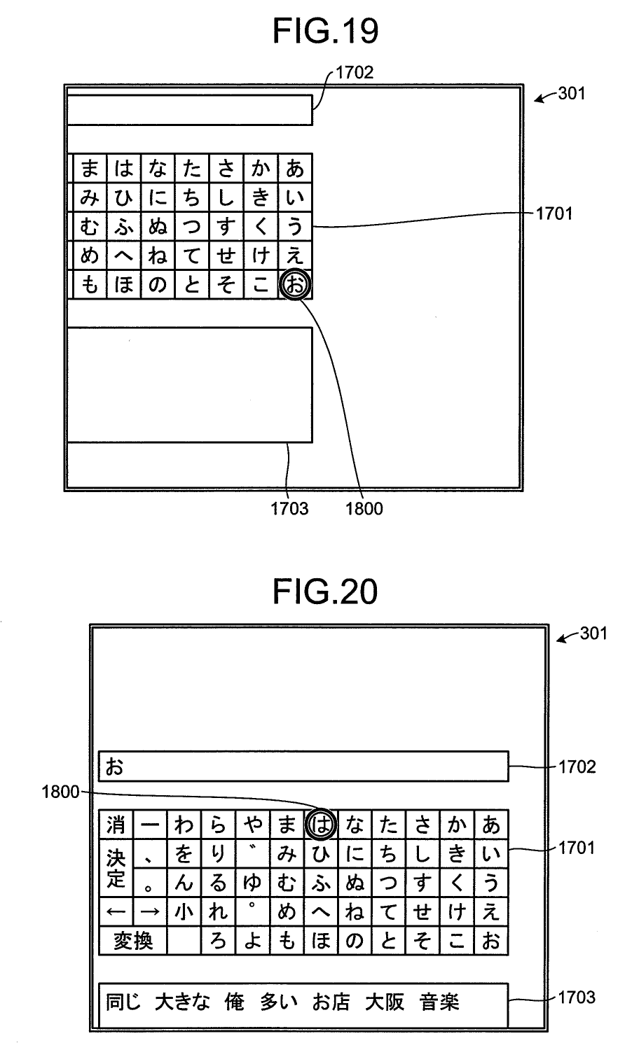

FIG. 19 is a schematic of the display screen when the character [symbol] is input. FIG. 19 depicts a state transitioned to from the state depicted in FIG. 18, by the user 101 facing the digital camera 100 to the right and downward to move the focus 1800 to the right and downward. The user 101 adjusts the direction in which the digital camera 100 faces so that the character [symbol] becomes centered on the display screen (the focus 1800 is on the character [symbol] ). The range in which the user 101 tilts the digital camera 100, as depicted in FIG. 8, is a slight amount.

With the focus 1800 on the character [symbol] , the user 101 presses the shutter button 206 and the character [symbol] is input to the character editing portion 1702 as an unconfirmed character string (reading/pronunciation). When the unconfirmed character string is displayed, character strings estimated from the character [symbol] are displayed in the candidate displaying portion 1703. As depicted in FIG. 19, the character pallet portion 1701 need not entirely fit within the display screen.

FIG. 20 is a schematic of the display screen when the character [symbol] is input. The state depicted in FIG. 20 is transitioned to from the state depicted in FIG. 19 by the user 101 facing the digital camera 100 to the left and upward to move the focus 1800 to the left and upward. The user 101 adjusts the direction in which the digital camera 100 faces so that the character [symbol] becomes centered on the display screen (the focus 1800 is on the character [symbol] ). With the focus 1800 on the character [symbol] , if the user 101 presses the shutter button 206, the character [symbol] in succession with the character [symbol] is input to the character editing portion 1702 as an unconfirmed character string (reading/pronunciation).

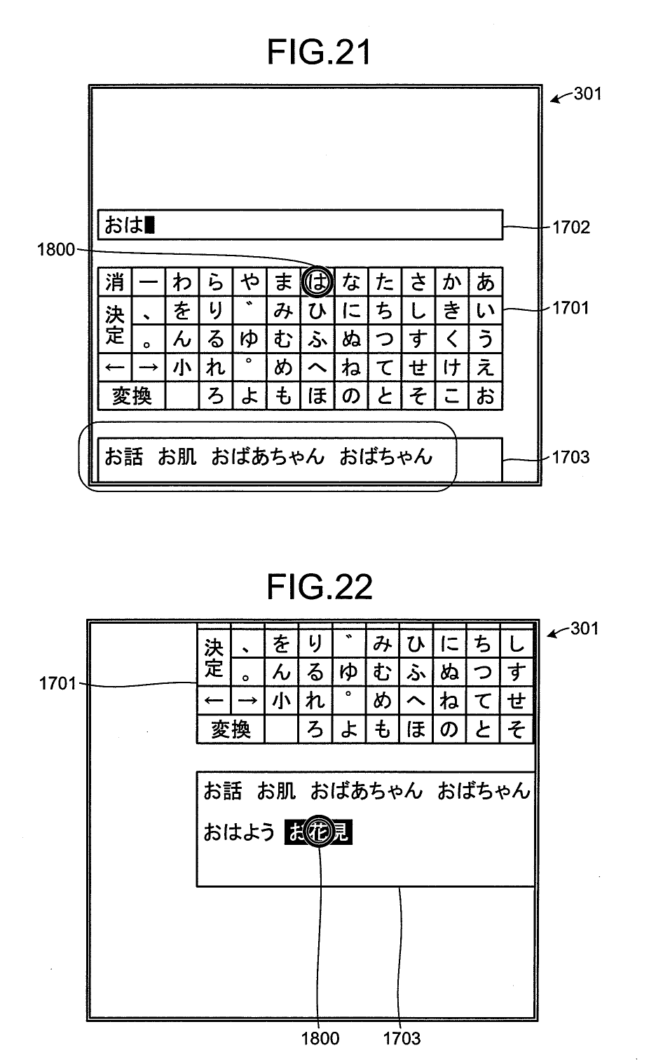

FIG. 21 is a schematic of the display screen when after the character [symbol] followed by the character [symbol] are input. FIG. 21 depicts a state where, as a result of the characters [symbol] and [symbol] being input, character strings estimated from [symbol] are displayed in the candidate displaying portion 1703. The first line displayed in the candidate displaying portion 1703 includes [symbol] , [symbol] , [symbol] , and [symbol] . In this display screen, a second row is not displayed, specifically, the second row including [symbol] is not displayed. By facing the digital camera 100 downward, the user 101 causes the focus 1800 to move downward and the second and subsequent rows are displayed in the candidate displaying portion 1703.

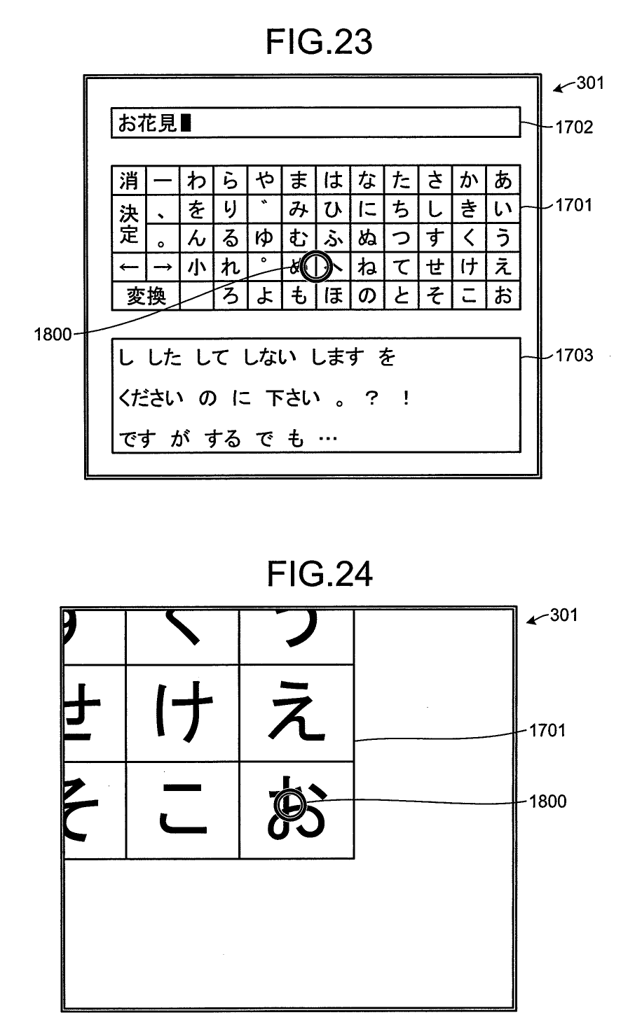

FIG. 22 is a schematic of the display screen when the focus 1800 is moved downward to cause the second and subsequent candidate rows to be displayed. [symbol] , which is not displayed in FIG. 21, is displayed in this display screen. The user 101 adjusts the direction in which the camera 100 faces to move the focus 1800 to be on the candidate [symbol] . In this state, if the user 101 presses the shutter button 206, the display screen transitions to the state depicted in FIG. 23.

FIG. 23 is a schematic of the display screen when a candidate is selected. As a result of the user selection, the confirmed [symbol] character string is input to the character editing portion 1702 as a confirmed character string. Further, the estimated candidates that have not been input are displayed in the candidate displaying portion 1703.

For example, the focus 1800 may be caused to move by a pressing of the shutter button 206 or a pressing of the direction button 303, to correct breaks, select a range of text, etc. In this case, a pointer on the screen does not move, rather content is moved to the center (focus 1800) of the screen to be pointed to.

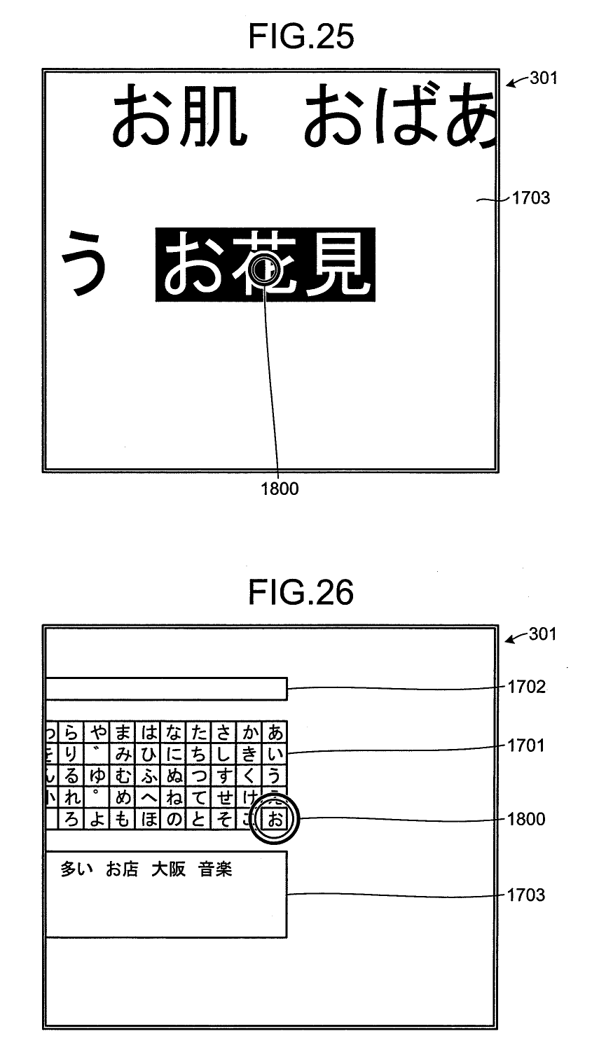

FIGS. 24 and 25 are schematics of the display screen when zoomed-in on. In FIG. 24, [symbol] is focused on and the user 101 presses the zoom-in side of the zoom button 302 to change the display magnification (scale) of the character pallet portion 1701. In FIG. 25, [symbol] is focused on and the user 101 presses the zoom-in side of the zoom button 302 to change the display magnification (scale) of the candidate displaying portion 1703.

Under the standard display scale, the character pallet portion 1701, the character editing portion 1702, and the candidate displaying portion 1703 are completely displayed on the entire display screen. However, under a zoomed in state, one portion is enlarged. Through such zooming in, the size in which the input keys are displayed becomes relatively large, thereby making selection of input keys easy and preventing input errors. Further, zooming in is not limited to operation of the zoom button 302 and may be, for example, by bringing the camera 100 closer to the user 101.

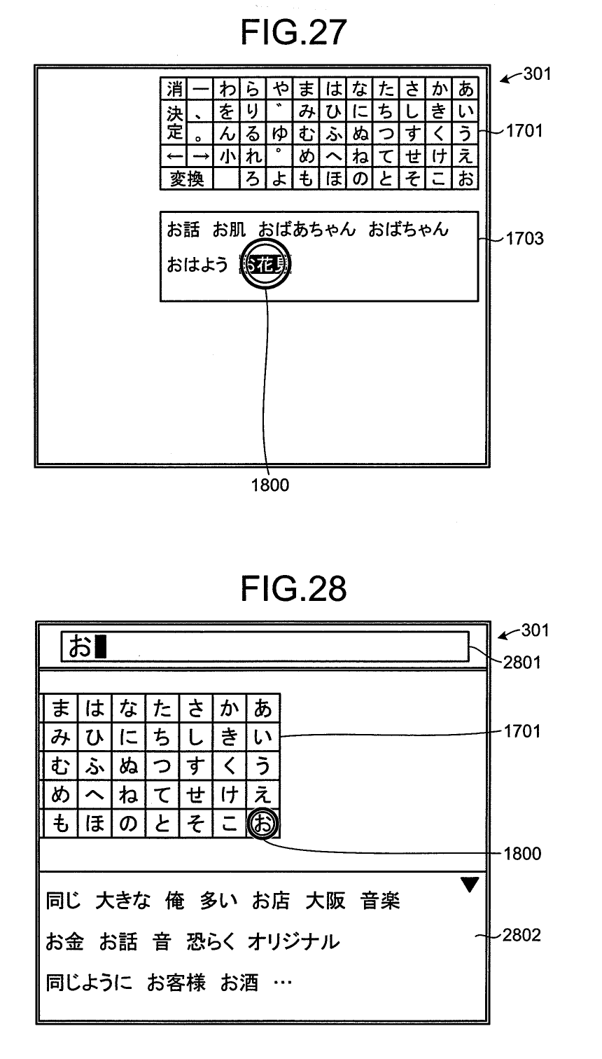

FIGS. 26 and 27 are schematics of the display screen when zoomed-out from. In FIG. 26, the character [symbol] is focused on and the user 101 presses the zoom-out side of the zoom button 302 to change the overall magnification (scale) of the display. In FIG. 27, the candidate [symbol] is focused on and the user 101 presses the zoom-out side of the zoom button 302 to change the overall magnification (scale) of the display.

With such zooming out, each portion may be reduced in size to reduce the amount of movement of the focus 1800. Areas that extend beyond the display screen may be reduced in size. Further, zooming out is not limited to operation of the zoom button 302 and may be, for example, by moving the camera 100 farther away from the user 101.

FIGS. 28 to 33 are schematics of the display screen when the character editing portion and the candidate displaying portion are fixed.

FIG. 28 depicts a state transitioned to from the state depicted in FIG. 18 by the user 101 facing the digital camera 100 to the right and downward. The user 101 adjusts the direction in which the digital camera 100 faces so that the character [symbol] is at the center of the display screen (the character [symbol] is focused on). Here, the display of a character editing unit 2801 remains fixed and does not move according to the movement of the focus 1800.

With the character [symbol] focused on, if the user 101 presses the shutter button 206, the character [symbol] is input to the character editing portion 2801 as an unconfirmed character string (reading/pronunciation). When unconfirmed character strings are displayed, candidates estimated from the character [symbol] are displayed simultaneously in the candidate displaying portion 2802. At this time, similar to the character editing portion 2801, the display of the candidate displaying portion 2802 does not move according to the movement of the focus 1800 and remains fixed.

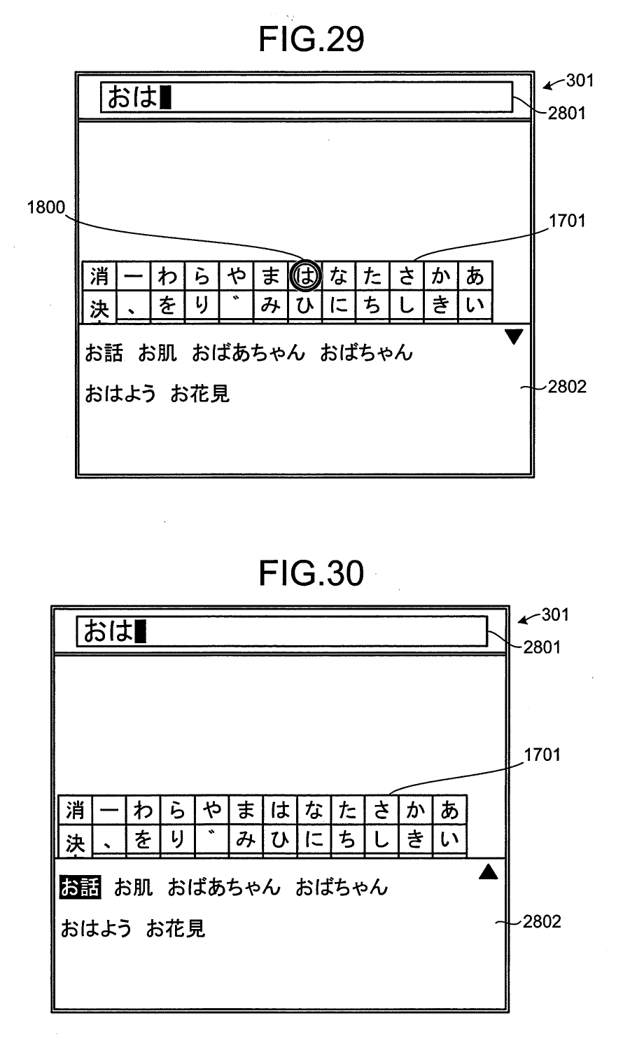

After the character [symbol] is input, the user 101 faces the digital camera 100 to the left and upward to place the focus 1800 on the character [symbol] as depicted in FIG. 29. At this time, the character pallet portion 1701 moves together with the movement of the focus 1800; however, the display of the character editing portion 2801 and the candidate displaying portion 2802 remains fixed. If the user 101 selects [symbol] , character strings estimated from [symbol] are displayed in the candidate displaying portion 2802.

In this state, for example, by pressing the direction button 303 downward, a cursor is displayed enabling selection of character strings in the candidate displaying portion 2802 as depicted in FIG. 30. At this time, the focus 1800 displayed in the character pallet portion 1701 disappears and the candidate displaying portion 2802 is highlighted. In this state, the user 101 presses the direction button or changes the direction in which the digital camera 100 faces, etc. to change the character string indicated by the cursor.

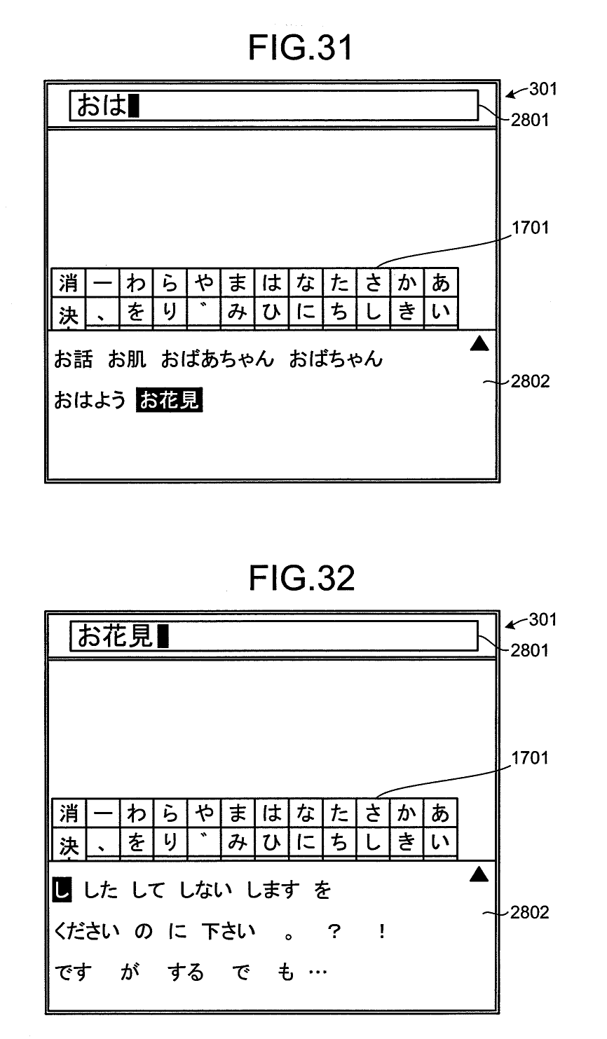

For example, if the user 101 presses the directional button 303 to the right and downward 1 time each, or faces the digital camera 100 downward to the right, the character string in the candidate displaying portion 2802 changes from [symbol] to [symbol] as depicted in FIG. 31. If the user 101 presses the shutter button 206 or the enter button 304, [symbol] is displayed in the character editing portion 2801 as depicted in FIG. 32 and a subsequent character may be input. The relationship between the direction in which the direction button 303 is manipulated and the movement of the display of the cursor when a character string in the candidate displaying portion 2802 is selected, is not limited hereto, and may be arbitrarily set according to specifications.

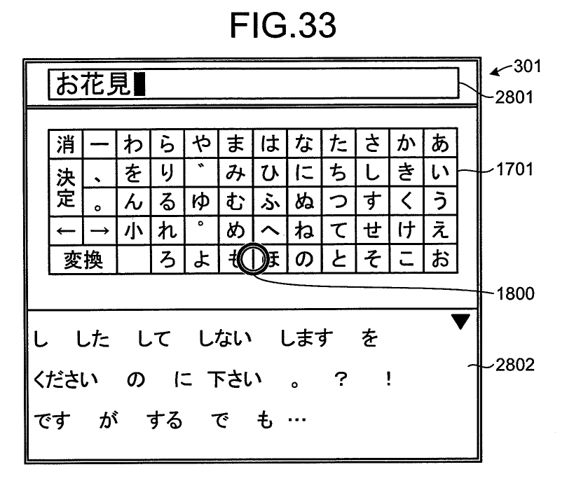

Estimated candidates that have not been input are automatically displayed in the candidate displaying portion 2802. In this state, a cursor is displayed in the candidate displaying portion 2802, and the focus 1800 is not displayed in the character pallet portion 1701. If a target sought by the user 101 is among the candidates displayed in the candidate displaying portion 2802, operation for candidate selection is possible as is. On the other hand, if the target of the user 101 is not among the candidates and characters are to be newly input, for example, the user 101 presses the direction button 303 upward to display the focus 1800 on the character pallet portion 1701, as depicted in FIG. 33.

In this case, the candidate displaying portion 2802 is not highlighted. Further, when the focus 1800 is again displayed in the character pallet portion 1701, the position of the focus 1800 returns, for example, to the initial position (center).

As described, according to the digital camera 100 of the embodiments, the soft keyboard 103 is focused according to the angular state of the digital camera 100, and since control is executed to receive selection (by operator input) of selectable items on the soft keyboard 103, the user 101 perceives the selectable items as objects and is able to move the focus (move the focus to the center of a selectable item) as if looking at an object. Thus, selection of selectable items by the user 101 is simple and easy. Consequently, quick and accurate user input becomes possible.

In the embodiments, soft keyboards 103 are displayed at given positions within a spherical 3-dimensional virtual space 102, the position of the focus is moved in the same direction as the angular direction of the apparatus, and the soft keyboard 103 is caused to be focused; hence, the position of the soft keyboard 103, the size, the direction, the distance, etc. may be freely set and regardless of the position and posture of the user 101, etc., input is possible that is easy and has good operability from the standpoint of the user 101.

In the embodiments, when the soft keyboard 103 is focused, since control is executed to receive selection that is with respect to the focused soft keyboard 103 and by operator input via the shutter button 206, selection of the soft keyboard 103 and character input can be executed in an extremely simple manner, a manner identical to taking a photograph of an object. Further, dirtying of the display 301 by the user 101 touching the display, such as in the case of a touch panel, may be prevented.

In the embodiments, since the soft keyboard 103 can be zoomed-in on and out from using the zoom button 302 identical to operation when taking a photograph, the user 101 can display the soft keyboard in an arbitrary and desirable size. Therefore, the soft keyboard 103 can be displayed in a size appropriate according to each user 101 and thus, operability improves and quick input becomes possible.

In the embodiments, the soft keyboards 103 are arranged within the spherical 3-dimensional virtual space 102; however, configuration is not limited hereto and other soft keyboards may be arranged outside the 3-dimensional virtual space 102, where the soft keyboards 103 inside the 3-dimensional virtual space 102 are arranged overlapping the other soft keyboards. In this case, if the soft keyboards 103 are zoomed-in on and a magnification error occurs, the screen of the soft keyboard 103 that protrudes out is displayed and the soft keyboards arranged outside the 3-dimensional virtual space 102 are displayed. In other words, the soft keyboard 103 focused in front is moved further to the back to enable other soft keyboards to be displayed. By this configuration, even when the selectable items on the soft keyboard 103a, etc. are numerous, the selectable items can be overlapped in a direction extending away from the user thereby facilitating selection among numerous selectable items.

In the embodiments, since the focusing position displayed at the start of input is the initial position and the soft keyboard 103 is focused, regardless of the posture and viewing angle of the user 101 when looking at the display 301, the first position displayed is regarded as the front to enable input. Specifically, for example, even when the user 101 is lying down and looks at the display 301, regardless of the posture of the user 101, input is possible where the first position displayed is regarded as the front.

The embodiments are extremely effective for input with respect to selection of items using numerous input keys such as that of the soft keyboard 103. For example, conventionally, when 3 neighboring keys are to be selected, cumbersome and extensive operations are necessary to move the cursor, e.g., the apparatus has to be shaken 3 times vertically or horizontally. However, according to the digital camera 100 of the embodiments, comparable to taking a photograph, input key can be selected by a minimal amount of operations to move only the focus 1800. Thus, the digital camera 100 according to the embodiments enables smooth selection of input keys. Selectable items are not limited to the soft keyboard 103 and as described above, may be photographed images, a schedule planner, etc. In this case as well, even if there are numerous images, schedule planners, etc. to select from, the embodiments are effective.

In the embodiments, in addition to the characters displayed on the soft keyboard 103, selected characters are displayed in the character editing portion 1702, and character strings estimated from the characters displayed in the character editing portion 1702 are displayed in the candidate displaying portion 1703; hence, the user 101 can easily recognize the display and the configuration supports user input to enable simple and fast input by the user.

In the embodiments, when the characters on the soft keyboard 103 are focused, the display of the character editing portion 2801 and the candidate displaying portion 2802 may be fixed without being moved according to the movement of the focusing. Thus, a simple screen is displayed, making input quick and easy for the user 101.

In the embodiments, since the internal triaxial accelerometer 411 is used as the detecting unit 502, a digital camera 100 having a simple configuration and capable of detecting its angular state can be implemented.

In the embodiments, the user input apparatus of the present invention is implemented by the digital camera 100; however, configuration is not limited hereto and implementation may be by a mobile telephone apparatus, PDA, etc. having a photographing function.

As described, according to the user input apparatus, the digital camera, the input control method, and computer product of the present invention, quick and accurate user input becomes possible.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2008-258336 filed in Japan on Oct. 3, 2008.

What is claimed is:

1. A user input apparatus comprising:
a display screen that displays selectable items;
a receiving unit that receives operational input from a user;
a display control unit that causes to be displayed on the display screen as objects, the selectable items and a 3-dimensional virtual space centered about a vantage point of the user viewing the display screen;
a detecting unit that detects an angular state of the user input apparatus;
a focusing unit that focuses a selectable item according to the detected angular state; and
a control unit that performs control causing reception of selection that is made via the operational input from the receiving unit and with respect to the selectable item focused by the focusing unit.

2. The user input apparatus according to claim 1, wherein
the display control unit causes the 3-dimensional virtual space to be displayed as a sphere together with the selectable items displayed at given positions in the 3-dimensional virtual space, and
the focusing unit moves a focusing position in a direction identical to an angular direction of the user input apparatus.

3. The user input apparatus according to claim 1, wherein
the receiving unit includes a first receiving unit for performing photography, and
the control unit, when the selectable item is focused by the focusing unit, performs control causing reception of the selection that is made via the operational input from the first receiving unit and with respect to the focused selectable item.

4. The user input apparatus according to claim 3, wherein
the receiving unit includes a second receiving unit for zooming in or out from an object, and
the focusing unit causes zooming-in on or zooming-out from the selectable item based on the operational input from the second receiving unit.

5. The user input apparatus according to claim 1, wherein
the focusing unit sets a focusing position displayed when input commences as an initial position and focuses the selectable item.

6. The user input apparatus according to claim 1, wherein
the selectable item is a soft keyboard, and
the focusing unit focuses the soft keyboard according to the angular state detected by the detecting unit.

7. The user input apparatus according to claim 6, wherein
the selectable item is a character on the soft keyboard, and
the display control unit, in addition to focusable characters displayed on the soft keyboard, causes display of a character editing portion in which selected characters are displayed, and a candidate displaying portion in which character strings estimated from the characters displayed in the character editing portion are displayed.

8. The user input apparatus according to claim 7, wherein
the display controlling unit, when a character on the soft keyboard is focused by the focusing unit, causes fixed display of the character editing portion and the candidate display portion where the character editing portion and the candidate display portion do not move correspondingly with focus movement.

9. The user input apparatus according to claim 1, wherein
the detecting unit is formed by a triaxial accelerometer equipped in the user input apparatus.

10. A digital camera comprising:
the user input apparatus according to claim 1.

11. An input control method comprising:
receiving operational input from a user;
controlling display to cause to be displayed on a display screen as objects, selectable items and a 3-dimensional virtual space centered about a vantage point of the user viewing the display screen;
detecting an angular state;
focusing a selectable item according to the detected angular state; and
controlling to cause reception of selection that is made via the operational input at the receiving and with respect to the selectable item focused at the focusing.

12. A computer-readable recording medium storing therein an input control program that causes a computer to execute:
receiving operational input from a user;
controlling display to cause to be displayed on a display screen as objects, selectable items and a 3-dimensional virtual space centered about a vantage point of the user viewing the display screen;
detecting an angular state;
focusing a selectable item according to the detected angular state; and
controlling to cause reception of selection that is made via the operational input at the receiving and with respect to the selectable item focused at the focusing.
